(19) United States
(12) Patent Application Publication
(10) Pub. No.: US 2023/0242060 A1
(43) Pub. Date: Aug. 3, 2023

(54) REROUTING TRAFFIC POST VEHICLE CRASH

(71) Applicant: Continental Automotive Systems, Inc., Auburn Hills, MI (US)

(72) Inventors: Ulrich Stählin, Eschborn (DE); Brian J Marlett, Macomb, MI (US); Mitchell E Clelland, Commerce Township, MI (US); Paul D Bingham, Canton, MI (US)

(73) Assignee: Continental Automotive Systems, Inc., Auburn Hills, MI (US)

(21) Appl. No.: 17/649,681

(22) Filed: Feb. 2, 2022

(51) Int. Cl. B60R 21/0136; G08G 1/01; G07C 5/08; G07C 5/00; H04W 4/44

(52) U.S. Cl. CPC B60R 21/0136; G08G 1/0112; G08G 1/0141; G07C 5/0808; G07C 5/008; H04W 4/44; B60R 2021/0027

(57) ABSTRACT

A vehicle diagnostic and communication system and method provides for recognizing a collision event with at least one device associated with a safety system of a vehicle and diagnosing operational capability of vehicle operating systems with an onboard vehicle controller in response to the recognized collision event. The diagnosis provides a determination of a severity of damage to the vehicle operating systems that is used to determine an impact on traffic proximate to the collision and transmit a communication based on the determined impact on traffic to other vehicles and an infrastructure device proximate the collision event.

### TECHNICAL FIELD

The present disclosure relates to method and system for rerouting traffic based on a severity of a collision event.

### BACKGROUND

Vehicles include safety systems that are actuated in response to a collision event. The safety systems gather information indicative of a severity of the collision and may communicate that information to emergency services. Traffic systems may communicate the location of a collision but currently provide no further information. Automotive suppliers and manufactures continually seek to improve vehicle safety, efficiency and capabilities.

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method of managing traffic according to a disclosed example embodiment includes, among other possible things, recognizing a collision event with at least one device associated with a safety system of a vehicle, diagnosing operational capability of vehicle operating systems with an onboard vehicle controller in response to the recognized collision event, determining a severity of damage to the vehicle operating systems based on the diagnoses, determining an impact on traffic proximate to the collision based on the determined severity of damage and transmitting a communication based on the determined impact on traffic to other vehicles and an infrastructure device proximate the collision event.

Another embodiment of the foregoing method includes receiving information from the infrastructure device proximate the vehicle relating to the collision event and further comprising determining the impact on traffic, based in-part, on the received information from the infrastructure device.

Another embodiment of any of the foregoing methods, further includes sending the generated communication for receipt by vehicles approaching the collision event.

Another embodiment of any of the foregoing methods, further includes sending the generated communication to the infrastructure device.

Another embodiment of any of the foregoing methods, wherein the communication includes information regarding the determined severity of damage to at least one vehicle involved in the collision event and the determined impact on traffic.

Another embodiment of any of the foregoing methods, wherein the communication includes instructions for rerouting traffic relative to a determined location of the collision event.

Another embodiment of any of the foregoing methods, wherein the communication includes instructions for routing responsive services to the location of the collision event.

Another embodiment of any of the foregoing methods, wherein the infrastructure redefines an existing traffic control device timing to a new traffic control device timing to route traffic to accommodate the collision event.

Another embodiment of any of the foregoing methods, wherein the communication includes information indicative of severity of damage to at least one vehicle involved in the collision event.

Another embodiment of any of the foregoing methods, wherein recognizing the collision event comprises actuation of the at least one device associated with the vehicle safety system.

Another embodiment of any of the foregoing methods, wherein the infrastructure device generates information indicative of a location and orientation of at least one vehicle involved in the collision event.

Another embodiment of any of the foregoing methods, wherein diagnosing operational capability comprises confirming operation of each of a plurality of vehicle operating systems.

Another embodiment of any of the foregoing methods, wherein diagnosing operational capability comprises confirming operation of a plurality of occupant comfort systems.

A vehicle diagnostic and communication system according to another disclosed example embodiment includes, among other possible things, a controller with computer executable instructions configured to recognize a collision event with at least one device associated with a safety system of a vehicle, diagnose operational capability of vehicle operating systems with an onboard vehicle controller in response to the recognized collision event, determine a severity of damage to the vehicle operating systems based on the diagnoses, determine an impact on traffic proximate to the collision based on the determined severity of damage and transmit a communication based on the determined impact on traffic to other vehicles and an infrastructure device proximate the collision event.

In another example embodiment of the foregoing vehicle diagnostic and communication system, the controller is further configured to receive information from an infrastructure device proximate the vehicle relating to the collision event and determine the impact on traffic, based in-part, on the received information from the infrastructure device.

In another example embodiment of any of the foregoing vehicle diagnostic and communication systems, the controller is further configured to send the generated communication for receipt by vehicles approaching the collision event and to the infrastructure device.

In another example embodiment of any of the foregoing vehicle diagnostic and communication systems, wherein the communication includes information regarding the determined severity of damage to at least one vehicle involved in the collision event and the determined impact on traffic.

In another example embodiment of any of the foregoing vehicle diagnostic and communication systems, wherein the communication includes instructions for rerouting traffic relative to a determined location of the collision event.

A computer readable medium according to another disclosed example embodiment includes instructions executable by a controller for managing traffic based on damage severity resulting from a collision event, wherein the instructions comprise instructions prompting an in-vehicle controller to recognize a collision event with at least one device associated with a safety system of a vehicle diagnose operational capability of vehicle operating systems with an onboard vehicle controller in response to the recognized collision event determine a severity of damage to the vehicle operating systems based on the diagnoses determine an impact on traffic proximate to the collision based on the determined severity of damage and transmit a communication based on the determined impact on traffic for vehicles to other vehicles and an infrastructure device proximate the collision event.

Another example embodiment of the foregoing computer readable medium further includes instructions prompting operation of the controller to receive information from an infrastructure device proximate the vehicle relating to the collision event and determine the impact on traffic, based in-part, on the received information from the infrastructure device.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic illustration of a vehicle including an example disclosed control system.

FIG. 2 is a schematic view of a roadway and intersection including intelligent traffic infrastructure.

FIG. 3 is a flow diagram illustrating an example disclosed embodiment.

### DETAILED DESCRIPTION

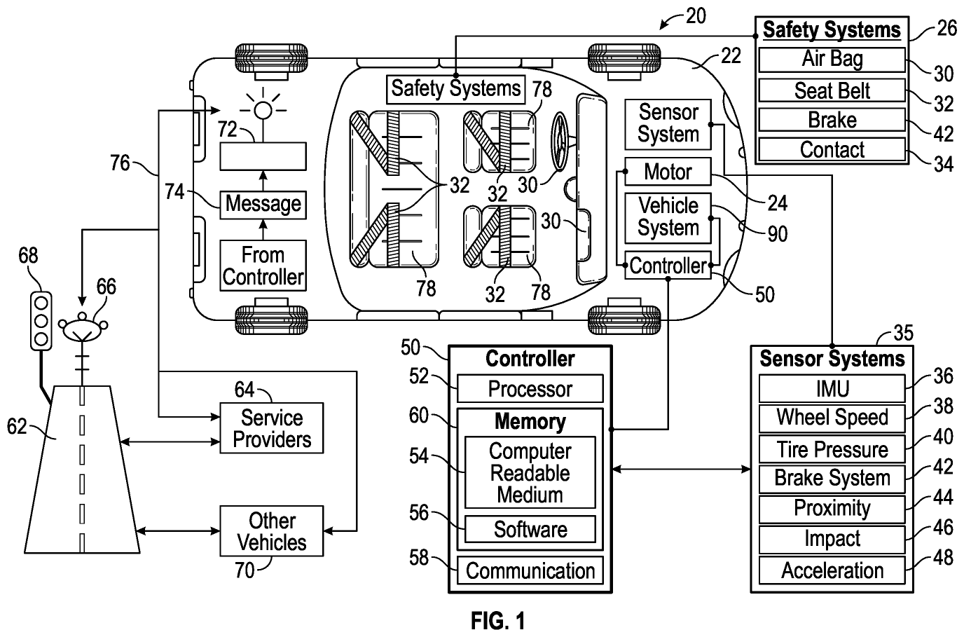

Referring to FIG. 1, an example diagnostic and communication system 20 for a vehicle 22 diagnoses vehicle health responsive to a collision event and uses that information to ascertain impacts on traffic and surrounding traffic infrastructure. The system 20 further communicates information indicative of vehicle health along with information regarding the impact the collision event may have on traffic.

A disclosed example system 20 embodiment communicates information for rerouting by other vehicles and for tailoring of traffic control device operation that fits the severity of the collision event. As appreciated, no two collision events are the same and therefore simply indicating the occurrence of a collision event may not be sufficient to enable an appropriate response by other vehicles and surrounding infrastructure devices. In some instances, the collision event is minor and little to no traffic disruption occurs and rerouting is not necessary. In other instances, the collision event may result in several vehicles blocking a roadway and thereby warrant a significant change in routing of other vehicles and modification to timing of traffic lights. Accordingly, the disclosed example system 20 provides for appropriate rerouting of traffic and tailoring of the operation of traffic infrastructure devices.

The disclosed example vehicle 22 includes a motor 24, sensor systems 35, vehicle operating systems 90 and safety systems 26. In one disclosed example embodiment, the vehicle safety systems 26 include safety devices, such as for example, airbags 30, seat belts 32, automated brake systems 42 as well as contact sensors 34 for detecting contact. The devices of the safety system 26 are disclosed by way of example and it is within the contemplation of this disclosure that other safety devices may be part of a vehicle safety system 26. The example safety system 26 generates a signal that is indicative of a severity of a collision event.

The sensor systems 35, in one disclosed example embodiment, include an inertial measurement unit (IMU) 36, wheel speed sensor 38, tire pressure sensor 40, brake system sensors 42, proximity sensors 44 and acceleration sensors 48. Other sensors systems may also be included and are within the contemplation and scope of this disclosure.

The sensor systems 35 provide information that is indicative of vehicle odometry and also provide information utilized by the safety systems 26 to prompt actuation. Information from the sensor systems 35 may also be utilized to diagnose vehicle health and operational condition.

A controller 50 is schematically illustrated and includes a processor 52, a memory device 60, a computer readable medium 54 and a communication module 58. Software instructions 56 may be stored on the memory device 60 and/or the computer readable medium 54.

The example controller 50 may be a separate controller dedicated to the control system 20 are may be part of an overall vehicle controller. Accordingly, example controller 50 relates to a device and system for performing necessary computing and/or calculation operations of the control system 20. The controller 50 may be specially constructed for operation of the control system 20, or it may comprise at least a general-purpose computer selectively activated or reconfigured by software instructions 56 stored in the memory device 60. The computing system can also consist of a network of (different) processors.

The instructions for configuring and operating the controller 50, the control system 20 and the processor 52 are embodied in the software instructions 56 that may be stored on a computer readable medium 54. The computer readable medium 54 may be embodied in structures such as, but is not limited to, any type of disk including floppy disks, optical disks, CD-ROMs, magnetic-optical disks, read-only memories (ROMs), random access memories (RAMS), EPROMs, EEPROMs, magnetic or optical cards, application specific integrated circuits (ASICs), or any type of media suitable for storing electronic instructions, and each coupled to a computer system bus. The disclosed computer readable medium may be a non-transitory medium such as those examples provided.

Moreover, the software instructions 56 may be saved in the memory device 60. The disclosed memory device 60, may include any one or combination of volatile memory elements (e.g., random access memory (RAM, such as DRAM, SRAM, SDRAM, VRAM, etc.) and/or nonvolatile memory elements (e.g., ROM, hard drive, tape, CD-ROM, etc.).

The software instructions 56 in the memory device 60 may include one or more separate programs, each of which includes an ordered listing of executable instructions for implementing logical functions. The disclosed controller 50 is configured to execute the software instructions 56 stored within the memory device 60, to communicate data to and from the memory device 60, and to generally control operations pursuant to the software. Software in memory, in whole or in part, is read by the processor 52, perhaps buffered within the processor, and then executed.

A communications device in the form of a transceiver 72 is in communication with the controller 50. The transceiver 72 provides for the transmission and receipt of messages from wireless networks 62 along with other communication systems. In one disclosed example, the transceiver 72 provides for communication through a vehicle to everything (V2X) system. V2X communication protocol enables communication between surrounding vehicles, traffic infrastructure devices 66 and traffic control devices 68. Moreover, the V2X communication protocol may provide communication with any other infrastructure systems that provide useful information to an area proximate the vehicle 22.

Although the transceiver 72 mounted in the vehicle 22 is disclosed by way of example, other communication devices that receive and exchange information with the vehicle controller 50 may also be utilized and are within the contemplation of this disclosure. For example, a vehicle operator's mobile phone coupled to the vehicle through a wireless interface may serve and the communication device for sending messages to the network and/or infrastructure devices 66. Moreover, the example network 62 may be any wireless communications network that enables communication between the vehicle 22 and various service providers 64.

In one disclosed example embodiment, the infrastructure devices 66 are sensors that gather information relating to traffic patterns. The sensors may be cameras, proximity sensors or any other devices that are capable of gathering and relaying information regarding traffic. The infrastructure devices 66 are disposed at various locations along a roadway.

The disclosed example traffic control device 68 is a traffic light that is capable of adjusting timing based on information that is received regarding traffic flow. The device 68 may be one or a group of devices that control traffic flow along a roadway. It is within the contemplation and scope of this disclosure that other traffic control devices could be utilized and would benefit from this disclosure.

The controller 50 of the vehicle 22 generates a message 74 that includes information relating to vehicle health to the surrounding infrastructure. The message 74 is sent as a wireless communication 76 to entities that may use the information. In one disclosed example embodiment, the wireless communication 76 is sent to other vehicles 70, service providers 64, the traffic infrastructure device 66 and traffic control devices 68. It should be understood that other entities may also receive and utilize the information from the wireless communication 76 and are within the contemplation and scope of this disclosure.

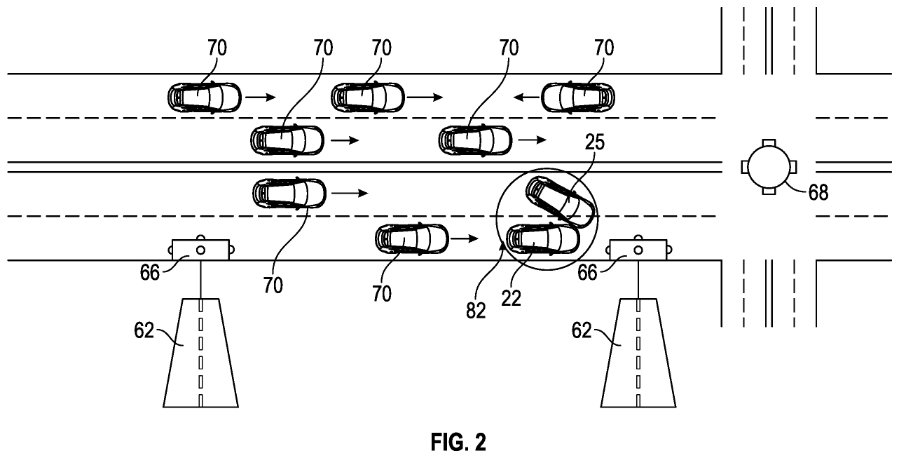

Referring to FIG. 2 with continued attention to FIG. 1, a roadway is shown that includes vehicles 70 moving relative to each other. Network devices 62 and traffic infrastructure devices 66 are disposed at intervals along the roadway. An intersection is shown with a traffic control device 68.

A collision event 82 between a vehicle 22 and vehicle 25 is schematically shown. The example collision event 82 is blocking one side of the roadway and therefore will result in a disruption to regular traffic flow.

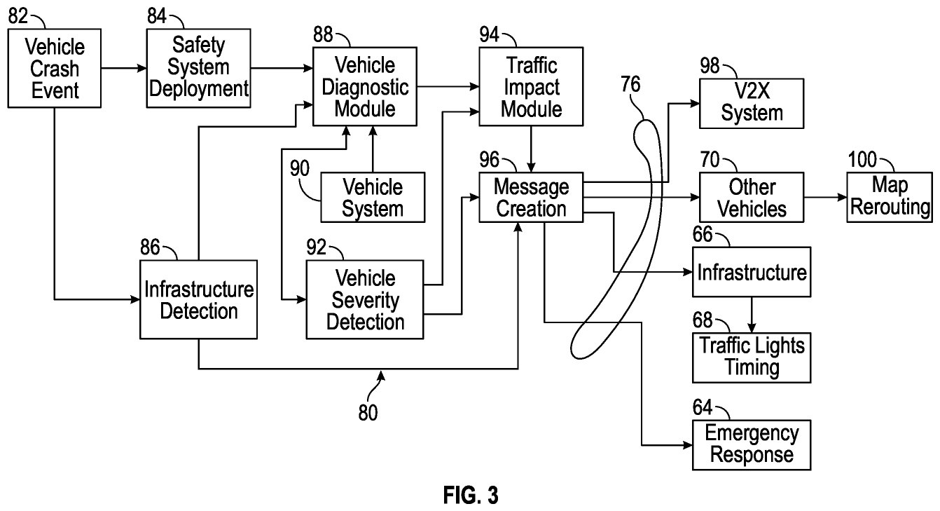

Referring to FIG. 3 with continued attention to FIGS. 1 and 2, an example embodiment of process steps performed by the example system 20 in response to a collision event is schematically shown at 80. While vehicles 22 and 25 are shown as part of the collision event 82, the disclosed process will be described with regard to the process undertaken by the vehicle 22. The vehicle 25 may also perform the same process steps and provide further information.

The collision event 82 prompts actuation of one of the safety systems 26 of the vehicle 22. In one disclosed embodiment, the airbags 30 deploy as schematically shown at 84. The collision event 82 is further detected by infrastructure devices 66 that are disposed along the roadway. Deployment of the airbags 30 prompts the system 20 to perform a diagnostic of the vehicle systems. In this disclosed embodiment, a vehicle diagnostic module 88 initiates the diagnostic routine of vehicle systems 90. The diagnostic routine may be tailored to the damage detected by the crash event and/or may be a full vehicle diagnostic of all vehicle systems 90.

Information from the diagnostic module 88 provides an indication of vehicle operability. Information from diagnostic routine is evaluated to provide a severity of damage determination schematically indicated at 92. The severity of damage information is utilized to determine what resources may be required to aid occupants and to address traffic disruptions. In this example embodiment, a traffic impact module 94 uses the information to provide information regarding possible disruptions caused by the collision event.

Information from the infrastructure is provided to the diagnosis module 88 to provide further information indicative of the severity of the collision event 82 and the potential for traffic disruption. Information from the infrastructure schematically indicated at 86 may originate from the infrastructure devices 66 and or from surrounding vehicles 70 that are equipped for vehicle to infrastructure communication. Information from the infrastructure includes location of the collision event, orientation of the vehicles 22, 25 involved in the event 82. The information may further include traffic specific information such as how many lanes, if any, are blocked and possible alternate routes for other vehicles 70 around the event.

Information regarding damage severity and traffic disruption is combined to create a message as indicated at 96. The message 96 is generated based information gathered from at least the vehicle 22. In one disclosed embodiment, the information used to create the message 96 includes information regarding damage severity from the vehicle 22 and information from the infrastructure devices 66. As appreciated, the more detailed the information, the better an appropriate response can be tailored to quickly provide aid to the occupants. Moreover, the better the response by the traffic infrastructure to reroute traffic as needed.

The created message 96 is sent to any devices, vehicles and infrastructure proximate the collision event. In this example, the message 96 is sent to other vehicles 70, infrastructure devices 66, traffic control devices 68 and emergency response systems 64. Furthermore, the created message is sent over a V2X system 98 for receipt by any vehicles, devices and/or infrastructure that is equipped to handle such communication.

Each of the receiving entities will process and use the information to tailor an appropriate response for that entity. Emergency responders may use the vehicle damage information to ready appropriate equipment to aid the occupants. Damage to the vehicle may be indicative of the need to aid in extraction of the occupants and/or inform of a specific medical treatment that might be needed.

Information sent to surrounding vehicles 70 can warn of the collision event 82 so that each vehicle may slow well before the collision event is visible. Slowing of the surrounding vehicles 70 can prevent secondary collision events. Moreover, the information to each of the vehicles 70 can be used to provide for map rerouting 100 as appropriate for each vehicle. The severity of damage information provided to other vehicles 70 can be used to determine if rerouting would be quicker than simply slowing and moving around the collision event. As appreciated, if the collision event is not blocking the roadway, it may be faster to simply slow down past the collision event and continue along a current route. However, if serious damage is communicated, it may be more efficient to reroute around the collision event.

The traffic light 68 may use the information to adjust traffic timing. The adjusted traffic light timing may be used to reduce the quantity of traffic past the collision. The traffic light 68 may also be utilized to shut down traffic in a certain direction to address traffic congestion. Additionally, the information provided may be used to adjust traffic light timing for several traffic lights to provide a faster route to the collision event for emergency response vehicles.

The message creation module 96 may generate a single message that is sent to all concerned entities or may generate different messages tailored to predefined needs of each of the entities. Moreover, the message creation module 96 may continue sending messages to the different entities until aid arrives. Additionally, the message creation module 96 may continue to generate messages with updated information as the collision event is addressed and cleared from the roadway.

In this disclosed example, the diagnostic module 88, the severity determination module 92, the traffic impact module 94, the message creation module 96 and the other modules illustrated in the flow diagram 80 are embodied as part of the software instructions 56 executed by the processor 52 of the controller. The software instructions 56 may divide each module as disclosed in this example embodiment and/or may divide each action, determination and analysis in a different matter in a sequence that differs from the disclosed example embodiment. It is within the contemplation and scope of this disclosure that the disclosed analysis, determination and actions may be implemented according to other sequences and at different order depending on specific application parameters, capabilities and requirements.

Accordingly, the example system prompts a comprehensive vehicle diagnostic process, gathers information from outside sources and generates a message based on the gathered information that is indicative of potential traffic disruptions. The information regarding damage to the vehicle and traffic disruptions may then be utilized to tailor an appropriate response by other vehicles, traffic control devices and service responders.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method of managing traffic comprising:
recognizing a collision event with at least one device associated with a safety system of a vehicle;
diagnosing operational capability of vehicle operating systems with an onboard vehicle controller in response to the recognized collision event;
determining a severity of damage to the vehicle operating systems based on the diagnoses;
determining an impact on traffic proximate to the collision based on the determined severity of damage; and
transmitting a communication based on the determined impact on traffic to other vehicles and an infrastructure device proximate the collision event.

2. The method as recited in claim 1, including receiving information from the infrastructure device proximate the vehicle relating to the collision event and further comprising determining the impact on traffic, based in-part, on the received information from the infrastructure device.

3. The method as recited in claim 1, further comprising sending the generated communication for receipt by vehicles approaching the collision event.

4. The method as recited in claim 3, further comprising sending the generated communication to the infrastructure device.

5. The method as recited in claim 1, wherein the communication includes information regarding the determined severity of damage to at least one vehicle involved in the collision event and the determined impact on traffic.

6. The method as recited in claim 5, wherein the communication includes instructions for rerouting traffic relative to a determined location of the collision event.

7. The method as recited in claim 6, wherein the communication includes instructions for routing responsive services to the location of the collision event.

8. The method as recited in claim 7, wherein the infrastructure redefines an existing traffic control device timing to a new traffic control device timing to route traffic to accommodate the collision event.

9. The method as recited in claim 7, wherein the communication includes information indicative of severity of damage to at least one vehicle involved in the collision event.

10. The method as recited in claim 1, wherein recognizing the collision event comprises actuation of the at least one device associated with the vehicle safety system.

11. The method as recited in claim 9, wherein the infrastructure device generates information indicative of a location and orientation of at least one vehicle involved in the collision event.

12. The method as recited in claim 1, wherein diagnosing operational capability comprises confirming operation of each of a plurality of vehicle operating systems.

13. The method as recited in claim 1, wherein diagnosing operational capability comprises confirming operation of a plurality of occupant comfort systems.

14. A vehicle diagnostic and communication system comprising:
a controller with computer executable instructions configured to:
recognize a collision event with at least one device associated with a safety system of a vehicle;
diagnose operational capability of vehicle operating systems with an onboard vehicle controller in response to the recognized collision event;
determine a severity of damage to the vehicle operating systems based on the diagnoses;
determine an impact on traffic proximate to the collision based on the determined severity of damage; and
transmit a communication based on the determined impact on traffic to other vehicles and an infrastructure device proximate the collision event.

15. The system as recited in claim 14, wherein the controller is further configured to receive information from an infrastructure device proximate the vehicle relating to the collision event and determine the impact on traffic, based in-part, on the received information from the infrastructure device.

16. The system as recited in claim 15, wherein the controller is further configured to send the generated communication for receipt by vehicles approaching the collision event and to the infrastructure device.

17. The system as recited in claim 16, wherein the communication includes information regarding the determined severity of damage to at least one vehicle involved in the collision event and the determined impact on traffic.

18. The system as recited in claim 17, wherein the communication includes instructions for rerouting traffic relative to a determined location of the collision event.

19. A computer readable medium comprising instructions executable by a controller for managing traffic based on damage severity resulting from a collision event, wherein the instructions comprise instructions prompting an in-vehicle controller to:
recognize a collision event with at least one device associated with a safety system of a vehicle;
diagnose operational capability of vehicle operating systems with an onboard vehicle controller in response to the recognized collision event;
determine a severity of damage to the vehicle operating systems based on the diagnoses;
determine an impact on traffic proximate to the collision based on the determined severity of damage; and
transmit a communication based on the determined impact on traffic to other vehicles and an infrastructure device proximate the collision event.

20. The computer readable medium as recited in claim 19, further including instructions prompting operation of the controller to receive information from an infrastructure device proximate the vehicle relating to the collision event and determine the impact on traffic, based in-part, on the received information from the infrastructure device.
